(19) United States
(12) Patent Application Publication
(10) Pub. No.: US 2009/0108029 A1
(43) Pub. Date: Apr. 30, 2009

(54) Microwavable spray container

(76) Inventor: Wayne Fromm, Toronto (CA)

Correspondence Address: Sandra J. Thompson, 335 Knoch Knolls Rd., Naperville, IL, 60565, US

(21) Appl. No.: 11/982,329

(22) Filed: Oct. 31, 2007

(51) Int. Cl. G01F 11/00; B67D 5/40

(52) U.S. Cl. 222/324; 239/337; 222/383.1

(57) ABSTRACT

An insulated, microwave-safe container with an attachable spray apparatus. Liquids can be heated in the container and sprayed out through the spray head.

### TECHNICAL FIELD

This invention relates to spray containers and more particularly to microwave-safe, heat-resistant spray containers.

### BACKGROUND OF THE INVENTION

Heated liquids are known to cut grease and make cleaning of many types of dirt and grime easier than cooler liquids. Automatic dishwashers and steam carpet cleaners both use heat, along with cleaning agents, to clean surfaces, but there is currently no easy or portable way to apply heated water or cleaning agents directly to surfaces throughout the house, automobile or boat, such as countertops, glass, and non-carpeted floors in order to clean and/or disinfect them. Traditional steam cleaning machines are limited in their portability by an electrical cord. Instead, consumers must often use harsh, toxic or environmentally unfriendly cleaners to clean these surfaces.

Currently, if consumers want to heat cleaning liquids, there is no easy way to do it. Current spray containers for cleaning products have parts that will spark in the microwave oven, and most are too tall to fit in a conventional microwave. Additionally, they are made of plastics which will deform if heated to too high a temperature and the spray heads also will likely deform when heated liquids are sprayed through them.

This invention gives users a practical way to easily apply heated liquids to dirty surfaces in order to clean them. Consumers will be able to use heat to clean without or with limited use of harsh cleansers, and could possibly do the cleaning completely with non-toxic, environmentally safe cleaners, such as heated solutions of white vinegar or washing soda. These heated solutions would penetrate sticky or stubborn residue and make cleaning easier.

### OBJECTS AND SUMMARY OF THE INVENTION

An object of the present invention is to provide a spray container which will be microwave-safe in a standard microwave oven, and which container with spray apparatus will also be heat-resistant, and which can be filled with water or cleaning fluids or other liquids and the container, with the liquid in it, can be heated in a microwave oven. Alternatively, the container can be filled with pre-heated water or cleaning fluids or other liquids.

In accordance with this invention, the container, including spray apparatus, is made completely of materials that are microwave-safe, and the outside of the container remains cool to the touch when microwaved or filled with heated liquid. The container can either be filled with liquid and heated in a microwave, or filled with heated water, such as water heated in a coffeepot or other heated liquids. The container can be made either with inner and outer walls and a space in between, which can be filled with some insulating material, or of a solid material which is microwave-safe and, possibly, insulating. The spray apparatus is removable from the container for filling, but is microwave-safe and will not deform on repeated exposure to heat or heated liquids.

The spray container can be used to spray heated water or cleaning liquids on surfaces to easily clean and disinfect them.

### BRIEF DESCRIPTION OF THE FIGURES

FIG. 1 is a sectional view of a microwave-safe spray container, with a removable spray apparatus in a housing, where the container has inner and outer walls and a space between the walls which is filled with an insulating material.

FIG. 2 is a sectional view of a microwave-safe spray container, with a removable spray apparatus in a housing, where the container has inner and outer walls with a space between the walls.

FIG. 3 is a sectional view of a microwave-safe spray container, with a removable spray apparatus in a housing, where the walls of the container are made of a microwave-safe material which will remain cool to the touch on the outside when either filled with liquid and heated in a microwave or filled with heated liquid.

FIG. 4 is a sectional view of a microwave-safe spray container, with a removable spray apparatus in a housing, where the container has inner and outer walls with a space between, where a portion of the space is filled with an insulating material, and where the rest of the space is filled with a heat-absorbing material.

FIG. 5 shows a sectional view of a microwave-safe spray apparatus.

### DETAILED DESCRIPTION

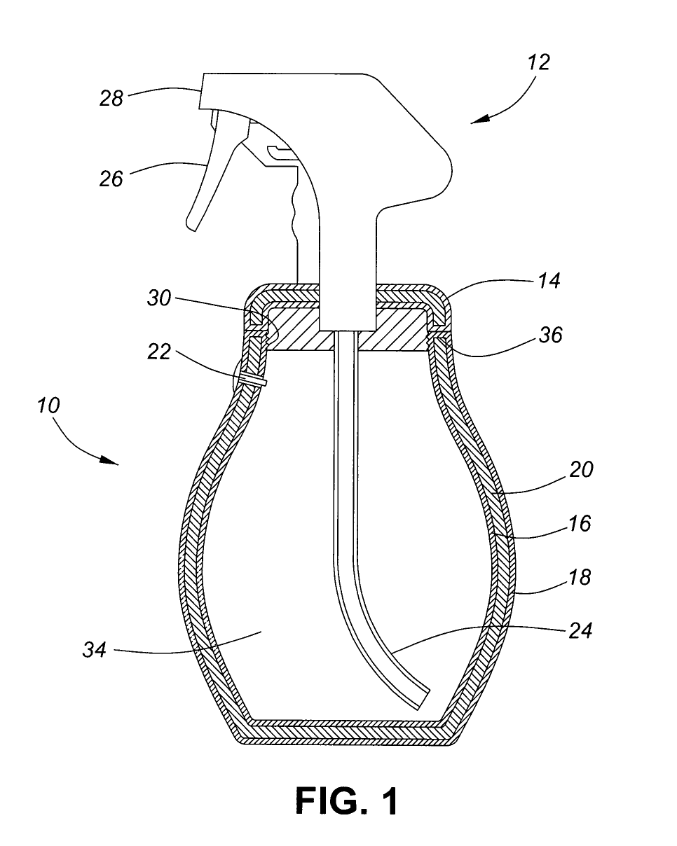

FIG. 1 shows a microwave-safe spray container, shown generally at 10, with a spray apparatus, shown generally at 12, which is held by a housing 14. The container in this figure has an inner wall 16, which defines a cavity 34, and an outer wall 18, which surrounds the inner wall, and a space between the outer and inner walls which is filled with foam 20 or some other insulating material. This figure also shows the inner wall connecting to the outer wall at the top of the container 36, although the walls do not need to connect. The outer wall is of a material that will remain cool to the touch after having been microwaved. The foam between the walls insulates the material inside the container and helps to keep it warmer longer, along with reducing the heat transfer to the outer shell, thus helping to keep the container from hurting or burning the user when it is picked up or touched.

A pressure-relief mechanism 22 extends from the exterior of the outer wall through to the interior of the inner wall, allowing the release of vapor or liquid from the container if pressure within the container builds up to a level higher than a pre-set limit. This pressure-relief mechanism can be shaped such that a whistling or other easily audible noise is emitted when vapor escapes through it, thus enabling users to be alerted that the liquid has reached its boiling point. This pressure-relief mechanism can alternatively be located in the spray apparatus or its attached housing.

The spray apparatus 12 is designed to be operable with one hand. It has a suction tube 24 which extends to or nearly to the bottom of the cavity in the container. When the trigger 26 of the spray apparatus is activated, liquid is drawn up through the suction tube into the spray apparatus, and exits the nozzle side 28 of the spray apparatus.

The housing of the spray apparatus can be of solid material or can have an inner and outer shell with or without a space in between, or it can be of some other construction. It is attachable to the container, either with threads 30 or by some other means, and the attachment is completely or nearly liquid-tight.

All of the components of both the container and the spray apparatus with its housing are of materials that are microwave-safe or are appropriately shielded so that they will not spark in the microwave. Those components that are exposed to the heated liquids are of materials that will not deform on repeated exposure to heat generated by boiling liquids. These materials can be polycarbonates, heat-resistant silicon or any other materials that meet the above criteria.

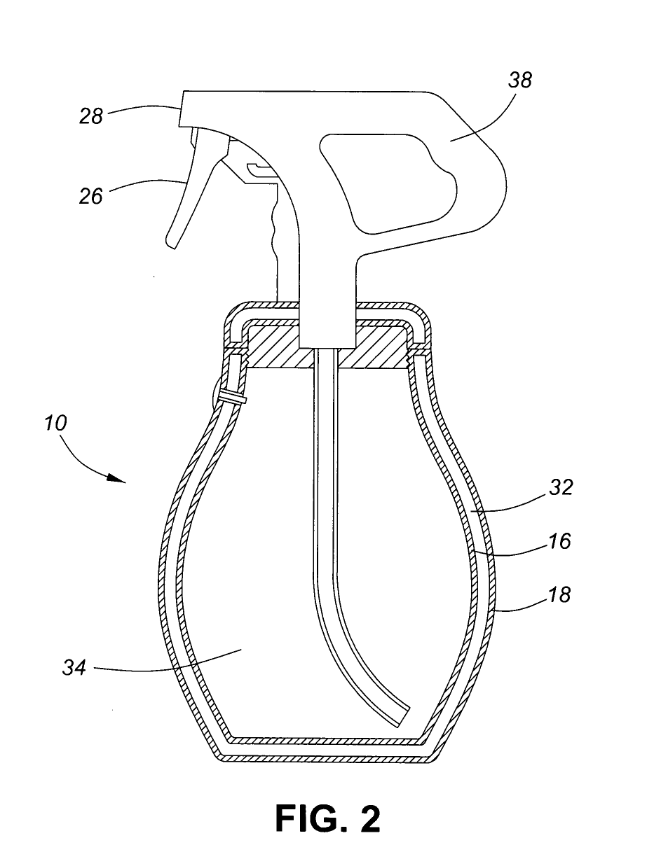

FIG. 2 shows a sectional view of a microwave-safe spray container, shown generally at 10, with an inner wall 16 which defines a cavity 34, and an outer wall 18 which surrounds the inner wall. In this figure, the space 32 between the inner and outer walls is either left empty or has a partial vacuum within it, possibly vacuum glass.

FIG. 2 also shows a handle 38 attached to the spray apparatus, although the handle could alternatively be attached to the container itself.

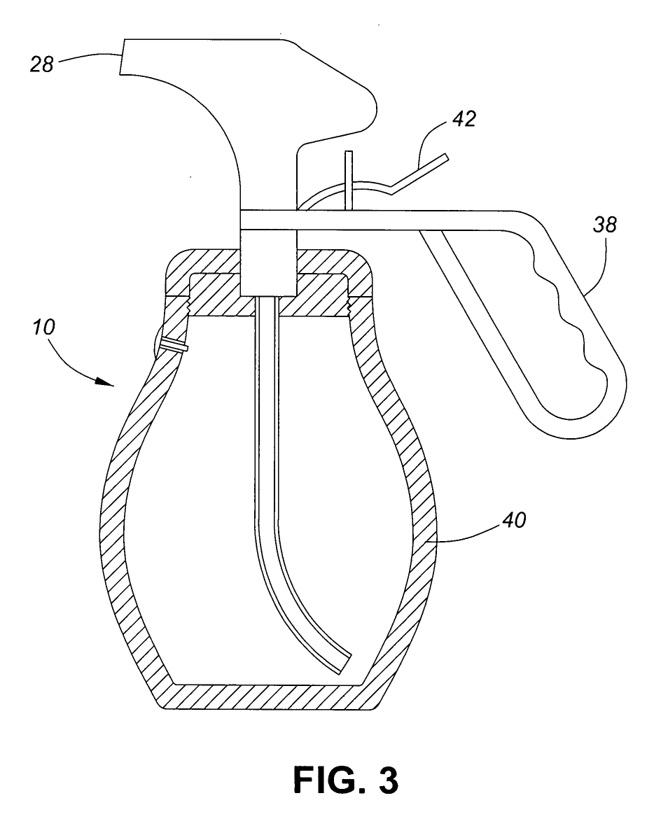

FIG. 3 shows a sectional view of a microwave-safe spray container, shown generally at 10, with a wall 40 which defines a cavity. The wall of the container is of one material, and the material serves to insulate the contents of the container while remaining cool to the touch on the outside of the container. In this figure, the trigger 42 is thumb-operable.

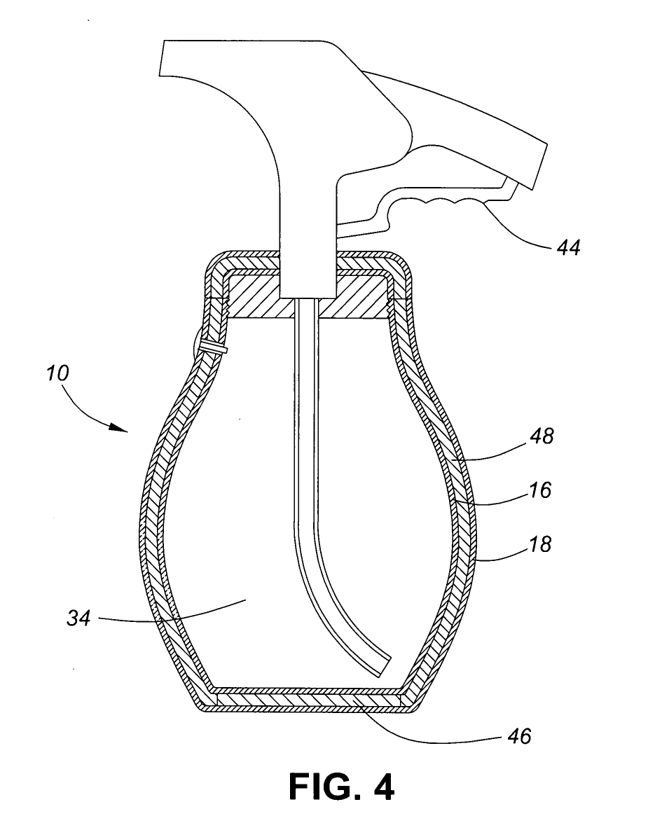

FIG. 4 shows a sectional view of a microwave-safe spray container, shown generally at 10, with an inner wall 16 which defines a cavity 34 and an outer wall 18 which surrounds the inner wall, and a space between the inner and outer walls. In this figure, a portion of the space between the walls 48, is filled with foam or some other insulating material, while another portion of the space 46, is filled with a heat-absorbing material such as stone or ceramic, which will further help keep the liquid inside the container warmer longer. The portion that is shown as being filled with foam or some other insulating material could alternatively have vacuum glass in it, or be solid material. Alternatively, the entire space could be filled with a heat absorbing material.

The different configurations of handles and walls in the above-described figures are not meant to represent the only combinations possible, as any handle or spray apparatus style can be used with any wall and/or insulation configuration.

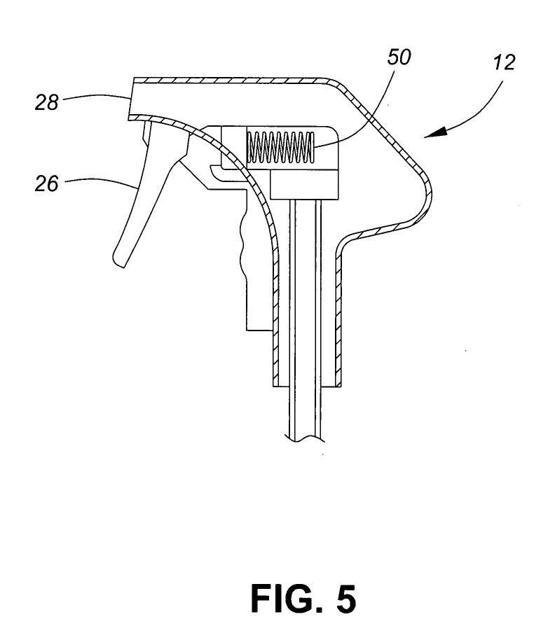

FIG. 5 shows a sectional view of a spray apparatus. All the materials in the spray apparatus, including the spring, are microwave-safe and heat resistant or, alternatively, are shielded or coated so that they will not spark in a microwave oven. The spring can be a compression spring.

The spray apparatus and its housing are removable from the container. Once removed, the container can then be filled with water or a liquid cleaning solution. The liquid can be pre-heated prior to being put into the container. Ideally, if a cleaning solution is used, it will be non-toxic and environmentally friendly, although any cleaning solution that can be heated can be used. The heated liquid will allow the use of smaller amounts of cleaning solutions, or milder cleaning solutions. If the liquid has not been preheated, the container, with the liquid inside, is placed in a microwave oven, either with or without the spray apparatus attached, and heated. As there is a pressure relief mechanism, the liquid inside the container can be heated to boiling without fear or boiling over or explosion. The outside of the container will remain cool to the touch, while the liquid inside remains hot. If a stone, ceramic or other heat absorbing layer is located between all or a portion of the inner and outer walls of the container, it will absorb some heat and release it back to the liquid later, thus keeping the liquid warmer for a longer period of time. If the pressure relief mechanism is configured so that it produces a whistle or other easily audible sound, the container with the spray apparatus in place can be heated until the whistle is heard, thus alerting the user that the contents have reached the boiling point.

The spray apparatus has a hand-operable trigger, in general usable with one hand, which allows the spraying of the liquid from the interior of the container onto surfaces to more easily clean and disinfect them. Once sprayed, the heated liquids will cut through many types of grease and grime more easily than cooler liquids, and enable faster and less arduous cleaning.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A microwave-safe spray container comprising:
a. a container, open at the top, having an inner wall which defines a cavity capable of holding an amount of liquid, and an outer wall which surrounds said inner wall, which walls define a space between them, and said inner and outer walls to be constructed of material which will remain cool to the touch when heated in a microwave oven, and
b. a spray apparatus which is held by a housing which can attach to the container, which spray apparatus is hand-operable, which has a suction tube extending to at or near the bottom of the container, and which spray apparatus has a trigger which, upon being activated, causes a portion of the liquid in the container to be sprayed out, said liquid being drawn up through the suction tube, said spray apparatus, to be constructed completely of heat-resistant materials which are not affected by microwaves,
and which container with the spray apparatus firmly attached can fit easily into a conventional microwave oven and, with liquid inside, be heated, whereby the liquid will heat up, but not the outer surface of the container.

2. A microwave-safe spray container comprising:
a. a container, open at the top, having a wall which defines a cavity capable of holding an amount of liquid, said wall to be constructed of material which will remain cool to the touch when heated in a microwave oven and/or when filled with heated liquid, and
b) a spray apparatus which is held by a housing which can attach to the container, which spray apparatus is hand-operable, which has a suction tube extending to at or near the bottom of the container, and which spray apparatus has a trigger which, upon being activated, causes a portion of the liquid in the container to be sprayed out, said liquid being drawn up through the suction tube, said spray apparatus, to be constructed completely of heat-resistant materials which are not affected by microwaves,
and which container, with the spray apparatus firmly attached can fit easily into a conventional microwave oven and, with liquid inside, be heated, whereby the liquid will heat up, but not the outer surface of the container.

3. The microwave-safe spray container as claimed in claim 1 in which the space between the inner and outer walls is filled with foam or other microwave-safe insulating material.

4. The microwave-safe spray container as claimed in claim 1 in which a portion of the space between the inner and outer walls of the container is filled with foam or some other microwave-safe insulating material, and the remainder of the space between the inner and outer walls is filled with ceramic, stone or some other heat-absorbing material.

5. The microwave-safe spray container as claimed in claim 1 or 2 in which the container has an outer covering or skin fabricated out of heat resistant silicone or similar material.

6. The microwave-safe spray container as claimed in claim 1 or 2, in which a pressure relief mechanism is situated in and extends through the wall or walls of the upper portion of the container from the exterior to the interior of the container, which mechanism serves to allow the release of steam or other vapors or liquids from the interior of the container if pressure within the container becomes higher than a pre-set threshold.

7. The microwave-safe spray container as claimed in claim 1 or 2, in which a pressure relief mechanism is situated in and extends through the housing of the spray apparatus of the container or through the spray apparatus itself, from the exterior through to the interior of the container, which mechanism serves to allow the release of steam or other vapors or liquids from the interior of the container if pressure within the container becomes higher than a pre-set threshold.

8. The microwave-safe spray container as claimed in claim 6, in which the pressure relief mechanism is configured so that, when steam or other vapor is released through it, a whistling or other easily audible sound is produced.

9. The microwave-safe spray container as claimed in claim 7, in which the pressure relief mechanism is configured so that, when steam or other vapor is released through it, a whistling or other easily audible sound is produced.

10. The microwave-safe spray container as claimed in claim 1 or 2 wherein the container is made of polycarbonate or other non-metallic material which is not affected by microwaves.

11. The microwave-safe spray container as claimed in claim 1 or 2 in which the suction tube is made of silicon, nylon, polycarbonate or some other heat-resistant material.

12. The microwave-safe spray container as claimed in claim 1 or 2 in which the spray apparatus has a compression spring which is made of microwave-safe and/or heat resistant material.

13. The microwave-safe spray container as claimed in claim 1 or 2 in which the spring in the spray apparatus is made of microwave-safe and/or heat resistant material.

14. The microwave-safe spray container as claimed in claim 1 or 2 in which the total height of the container and spray head combined is less than eight inches or twenty centimeters.

15. The microwave-safe spray container as claimed in claim 1 or 2 in which the outer wall connects to the inner wall at the top of the container.

16. The microwave-safe spray container as claimed in claim 1 or 2 in which the container or the spray apparatus and housing has an attached handle.

17. The microwave-safe spray container as claimed in claim 1 or 2 in which the container, when oriented in an upright position and with the spray apparatus attached will fit in a conventional microwave oven.

18. The microwave-safe spray container as claimed in claim 1 or 2 in which all portions of the container and the spray apparatus that can come in contact with high temperatures are made of materials that will not deform on repeated exposure to heat or heated liquids.
